(19) United States
(12) Patent Application Publication
(10) Pub. No.: US 2023/0420860 A1
(43) Pub. Date: Dec. 28, 2023

(54) SIGNALING SYSTEMS AND RELATED METHODS

(71) Applicant: AIRBORNE OUTFITTERS, LLC, Findlay, OH (US)

(72) Inventors: Jason Brett Evatt, Findlay, OH (US); Wesley R. Bonin, Hallsville, TX (US)

(21) Appl. No.: 18/339,774

(22) Filed: Jun. 22, 2023

Related U.S. Application Data
(60) Provisional application No. 63/354,645, filed on Jun. 22, 2022.

(51) Int. Cl. H01Q 15/00; G01S 7/41

(52) U.S. Cl. CPC H01Q 15/0013; G01S 7/411

(57) ABSTRACT

A system and method for identifying and locating a remote object is disclosed. The system includes a frequency selective surface having a substantially planar substrate including a radio frequency reflection element. The radio frequency reflection element is configured to a specific radio frequency and provides a reflected radio frequency of the specific radio frequency. The frequency selective surface is maintained in proximity to the remote object and associated with the remote object. The system includes a radio frequency emitter configured to emit the specific radio frequency of the radio frequency reflection element and a radio frequency receiver configured to receive the reflected radio frequency. An operating system is provided that includes a database and a location deriving capability. The operating system is configured to utilize the reflected radio frequency received by the radio frequency receiver to identify the remote object and determine a location of the remote object.

### CROSS-REFERENCE TO RELATED APPLICATIONS

This application claims the benefit of U.S. Provisional Application No. 63/354,645, filed on Jun. 22, 2022. The entire disclosure of the above application is incorporated herein by reference.

### FIELD

The present disclosure relates to methods and systems for signaling devices and systems.

### INTRODUCTION

This section provides background information related to the present disclosure which is not necessarily prior art.

The instant disclosure relates generally to radio frequency (RF) based systems as well as other electromagnetic spectrum based structures and methods for identification and/or location of persons and/or objects, including Personnel Recovery or Search and Rescue (SAR). Personnel Recovery can be defined as the sum of military, diplomatic, and/or civil efforts to prepare for and execute the recovery and reintegration of isolated personnel. Search and Rescue can be defined as the act of conducting a search, in an effort to locate lost or missing people or objects, recover and render aid to the victim, evacuating the victim to safety, or recovering a body or object Signaling devices, passive and/or active (e.g., electronic, audible, smoke, dyes, flares, panels, reflectors, etc.) may be used to activate a recovery system and/or confirm the location and/or identification of people and/or objects. Aerial (e.g., airplanes, helicopters, drones, national assets, etc.), aquatic (e.g., boats, ships, submarines, etc.), and terrestrial (e.g., trucks, cars, vans, tanks, motorcycles, etc.) platforms are typically employed during personnel recovery and SAR operations.

Electromagnetic radiation reflectors or frequency selective surfaces (FSS) are passive devices configured to reflect a specific electromagnetic radiation frequency or radio frequency (RF) across all applicable frequency ranges. FSSs are being used to facilitate locating persons, equipment, objects, or mark direction of movement. However, FSSs currently being used are part of a geodesic structure that has a plurality of surfaces on different planes, where one of the electromagnetic radiation reflectors is disposed on multiple surfaces of the plurality of surfaces, as disclosed in U.S. Pat. No. 9,748,643 titled IDENTIFICATION OR MESSAGING SYSTEMS AND RELATED METHODS, incorporated herein by reference in its entirety. A user of these current systems is required to quickly assemble or inflate the geodesic structure, attach the FSSs, and then position the assembly to reflect a unique RF signal. Once assembled and in position, the geodesic structure and attached FSSs, are designed to reflect or resonate the unique RF signal emitted by a plane or a satellite passing overhead. The unique reflected signal is received by a receiver, compared to stored signals to identify the personnel and/or equipment, and utilized to determine the location of the personnel and/or equipment. However, such systems require the user to actively assemble the geodesic structure and attached FSSs and then deploy the assembly. In certain situations, such as when the user is injured, captured or otherwise separated from the system, or when stealth prohibits the assembly and deployment of the system, the identification and location capabilities of the system cannot be utilized and the likelihood of completing the personnel recovery is reduced.

Accordingly, there is a need for signaling devices and systems that do not require assembly by a user, are concealable, and provide passive and/or active capabilities.

### SUMMARY

In concordance with the instant disclosure, a signaling device and system, has surprisingly been discovered. The present technology includes articles of manufacture, systems, and processes that relate to the positive identification and/or location of people and/or objects.

In one embodiment, a frequency selective surface includes a substantially planar substrate including a radio frequency reflection element. The radio frequency reflection element is configured to a specific radio frequency and provides a reflected radio frequency of the specific radio frequency.

In another embodiment, a system for identifying and locating a remote object includes a frequency selective surface, a radio frequency emitter, a radio frequency receiver, and an operating system. The frequency selective surface includes a substantially planar substrate including a radio frequency reflection element, where the radio frequency reflection element is configured to a specific radio frequency and provides a reflected radio frequency of the specific radio frequency. The frequency selective surface is maintained in proximity to the remote object. The radio frequency emitter can be configured to emit the specific radio frequency of the radio frequency reflection element and the radio frequency receiver can be configured to receive the reflected radio frequency. The operating system includes a database and a location deriving capability, where the reflected radio frequency can be associated with the remote object in the database. The operating system can be configured to utilize the reflected radio frequency received by the radio frequency receiver to identify the remote object and determine a location of the remote object.

In yet another embodiment, a method of identifying and locating an object is provided. The method includes providing a frequency selective surface having a substantially planar substrate including a radio frequency reflection element, where the radio frequency reflection element is configured to a specific radio frequency and provides a reflected radio frequency of the specific radio frequency. The method can also include associating the reflected radio frequency with the object, providing a radio frequency emitter configured to emit the specific radio frequency of the radio frequency reflection element, providing a radio frequency receiver configured to receive the reflected radio frequency, and providing an operating system having a database and a location deriving capability, where the reflected radio frequency is associated with the object being stored in the database. Furthermore, the method can include maintaining the frequency selective surface in proximity to the object and deploying the object remotely from the radio frequency emitter. The method also can include emitting the specific radio frequency of the radio frequency reflection element with the radio frequency emitter, reflecting the specific radio frequency with the radio frequency reflection element, receiving the reflected radio frequency with the radio frequency receiver, and utilizing the reflected radio frequency with the operating system to identify the object and determine a location of the object.

Personnel recovery can be defined as the sum of military, diplomatic, and/or civil efforts to prepare for and execute the recovery and reintegration of isolated personnel. Search and rescue can be defined as the act of conducting a search, in an effort to locate lost or missing people or objects, recover and render aid to the victim, evacuating the victim to safety, or recovering a body or object. Signaling devices, passive and/or active (e.g., electronic, audible, smoke, dyes, flares, panels, reflectors, etc.) may be used to activate a recovery system and/or confirm the location and/or identification of people and/or objects. Aerial (e.g., airplanes, helicopters, drones, national assets, etc.), aquatic (e.g., boats, ships, submarines, etc.), and terrestrial (e.g., trucks, cars, vans, tanks, motorcycles, etc.) platforms are typically employed during personnel recovery and SAR operations. The present technology provides personnel recovery or a signaling device system that have passive and/or active capabilities and can be overt and/or concealable.

In certain embodiments, a personnel recovery system (PRS) or a signaling device can be in the form of a demountable textile unit having externally positioned hook-and-loop structures. The PRS can include a graphene reflective backplane, a graphene antenna, an RF transceiver, and a graphene frequency selective surface (FSS). The graphene reflective backplane, graphene antenna, and graphene FSS surface are stacked within a hook and loop patch separated by foam spacers. In another configuration, the same constituent components are contained with an emblem or patch. The foam spacers allow a compact stacking of the graphene backplane, spacer, and FSS while still maintaining a minimum spacing of the components. This spacing can maintain the RF properties, such as gain and radiating frequency of the antenna or reflection frequency of the FSS. Having the conductive graphene components assembled without the spacer and/or closer together can detune these electrical and RF properties. The patch also can include a sewn in pouch to hold the RF transceiver and peripheral electronics, such as a battery or transmit button. Being contained within two layers of hook and loop, the PRS can be worn on body by the operator. In a military application, the PRS could be worn on uniform shoulder patches or else ware on equipment. In commercial applications a hiker or skier could wear the PRS on a backpack or article of clothing that contains hook and loop.

The backplane is printed with a conductive ink, such as VorINK® D101 from Vorbek Materials Corporation, so that it reflects the electromagnetic (EM) radiation of the antenna, limiting the operator's specific absorption rate (SAR) and allowing the patch to be flipped over to conceal the device's passive reflection if desired.

The graphene antenna is printed with a conductive ink, such as VorINK S912 from Vorbek Materials Corporation, and can be designed to radiate between 3 MHz and 30 GHz. For antenna designs lower than 1 GHz an electrically small antenna can be used in conjunction with a matching circuit to allow the antenna's footprint to fit within a wearable/concealable patch. The antenna, in conjunction with the RF transceiver, provides an active, beacon like, signaling capability to the operator. This signal can be used in predetermined use cases to communicate location or condition to a searching party. For example, in a military use case, a soldier wearing the PRS could have special instructions given prior to the mission so that if they were to become isolated, they would know how, when, and where to transmit a RF signal. Depending on these special instructions the signal can relay messages such as location, whether there are hostile persons close, whether they are injured, and whether they need rescue. In a commercial application, a lost hiker could use the active signaling component of the PRS to signal a distress call those authorities, such as park rangers of search and rescue, could use to triangulate the signal, pointing them to the isolated person or persons.

The graphene FSS includes a Battlefield Reflector for Isolated Travelers Everywhere (BARFITE™) device printed with VorINK® 5912. The BARFITE™ graphene FSS is an Airborne Outfitter's product based on U.S. Pat. No. 9,748,643, licensed from the Naval Surface Warfare Center's Crane Division.

The FSS can be designed as a stop band FSS so that it reflects specific electromagnetic frequencies while allowing all other frequencies to pass through. The antenna will be designed to operate at those frequencies designed to pass through the FSS. Searching parties can use radar assets to radiate electromagnetic waves in the range of 3 MHz-30 GHz, then the graphene FSS designed to operate in the same frequency will reflect specific frequencies or signatures back to the emitter/detector to indicate location to authorities.

Signatures from the FSS can be designed to provide multiple reflection peaks or a multi-radio frequency reflection pattern detected by emitters/receivers to provide a barcode like response that can be used to positively identify persons. An example of this is utilizing two peaks centered at 375 MHz and 475 MHz, although more peaks could be reflected by tailoring the FSS design, allowing the positive identification of many different individuals. Assets relevant to the passive reflection component of the PRS available to the military include but are not limited to the E2 Hawkeye or RC-135 Rivet Joint. In a commercial application, radio frequency emitters and/or radar devices could be used on any applicable platform, including, for example to search for reflected signatures of hikers or skiers wearing the PRS.

Additionally, the invention could be used to locate skiers trapped in an avalanche under snow banks. In this specific case, snow penetration of radar will be dependent on radar power and radiated frequency. Higher power and lower frequency will be capable of penetrating further underneath the snow. Helly Hansen, a Norwegian manufacturer and retailer of clothing and sports equipment uses a similar technology called RECCO™ for this specific purpose.

The RF transceiver will be chosen to work in conjunction with the accompanying antenna's radiating frequency. In one configuration a 900 MHz antenna can be implemented and used with a transceiver such as the HUM-900-PRC-UFL™ made by Linx Technologies. This specific receiver only required a power source such as a CR2477 coin cell battery and a button to activate transmit mode on the transceiver, and includes a built-in amplifier for transmission ranges up to 8 miles as well as 128-bit advanced encryption standard (AES) encryption capabilities. This is just one example of a commercial off the shelf (COTS) RF transceiver.

Others can be built from component parts for customized or specific working frequencies. In some military applications, transceivers with specific or even classified encryption and/or waveforms for low probability of intercept and low probability of exploitation (LPI/LPE) can be provided and only the operation frequencies need to be disclosed to the manufacturer.

In another embodiment of the PRS, the PRS could be used by military personnel in an escape and evasion scenario. For example, if an isolated soldier were to be abducted by hostile adversaries, the hostile party would be unlikely to take or remove the PRS from the abducted person because it is made to appear like an ordinary hook and loop patch. This will allow the abducted person to either continue to discretely transmit the distress signal using the active antenna component of the PRS or to be located by search parties or authorities using the passive FSS component of the PRS. There is also an embodiment of the PRS where the PRS can be manufactured to allow one or multiple FSS portions of the PRS to be discretely removed from a watch-like or wristband-like design so that they can be left behind to provide a trail for searching parties to follow using the radar assets described previously.

Applicable uses for the PRS include location and recovery of military or civilian isolated persons or equipment. These include but are not limited to isolated soldiers, abducted soldiers, covert target indication, lost hikers, lost skiers, skiers trapped in avalanche, downed military aircraft, downed commercial aircraft, as well as escaped or missing livestock.

In certain examples, data and simulations of FSS results can be modeled using the CST Studio Suite software. Using the software's CAD modeling capabilities, the FSS design was constructed using VorINK S912 conductive elements on a paper substrate. S12 transmission results showed reflection bandwidths <−10 dB. These results show that the FSS portion of the PRS can also be printed with VorINK 5912. The results indicate that the given design can reflect >90% (−10 dB) of incident radiation will be reflected back to an emitter between 327 MHz and 378 MHz, as well as between 471 MHz and 477 MHz. It also indicates that a double circular loop design can provide multiple reflection peaks, when compared to a singular circular loop design.

Computing devices can be provided, in accordance with an embodiment of the present PRS, to facilitate the operation of the PRS. A data processing system is provided that is representative of any electronic device capable of executing machine-readable program instructions. The data processing system may be representative of a smart phone, a computer system, PDA, or other electronic devices. Examples of computing systems, environments, and/or configurations that may represented by the data processing system include, but are not limited to, personal computer systems, server computer systems, thin clients, thick clients, wearable computer, hand-held or laptop devices, multiprocessor systems, microprocessor-based systems, network PCs, minicomputer systems, and distributed cloud computing environments that include any of the above systems or devices.

One computing device can includes respective sets of internal components and external components. Each of the sets of the internal components can include one or more processors, one or more computer-readable RAMs, and one or more computer-readable ROMs on one or more buses, and one or more operating systems and one or more computer-readable tangible storage devices. One or more of program functions and data files are stored on one or more of the respective computer-readable tangible storage devices for execution by one or more of the processors via one or more of the respective RAMs (which typically include cache memory). Each of the computer-readable tangible storage devices can be is a magnetic disk storage device of an internal hard drive. Alternatively, each of the computer-readable tangible storage devices is a semiconductor storage device, such as a ROM, an EPROM, flash memory or any other computer-readable tangible storage device that can store a computer program and digital information.

The internal components can also include a R/W drive or interface to read from and write to one or more portable computer-readable tangible storage devices, such as a CD-ROM, DVD, memory stick, magnetic tape, magnetic disk, optical disk or semiconductor storage device. The program function and the data files can be stored on one or more of the respective portable computer-readable tangible storage devices, read via the respective R/W drive or the interface and loaded into the respective computer-readable tangible storage devices.

Each set of internal components can also include network adapters or interfaces such as a TCP/IP adapter cards, wireless Wi-Fi interface cards, or 3G or 4G wireless interface cards or other wired or wireless communication links. The program function and data files can be downloaded to the computing device, respectively, from an external computer via a network (for example, the Internet, a local area network or other, wide area network) and the respective network adapters or interfaces. From the network adapters or interfaces, the program function and the data files in computing devices are loaded into the respective computer-readable tangible storage devices. The network may include copper wires, optical fibers, wireless transmission, routers, firewalls, switches, gateway computers and/or edge servers.

Each of the sets of external components can include a computer display monitor, a keyboard, and a computer mouse. External components can also include touch screens, virtual keyboards, touch pads, pointing devices, and other human interface devices.

The internal components also include device drivers to interface to the computer display monitor, the keyboard, and the computer mouse. The device drivers, R/W drive or interface and the network adapters or interfaces include hardware and software (stored in the storage device and/or the ROM).

Computer program code for carrying out operations of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top plan view of a frequency selective surface device according to an embodiment of the disclosure;

FIG. 2 is a top perspective view of the frequency selective surface device shown in FIG. 1 being bent out of plane;

FIG. 3 is a top perspective partially exploded view of a frequency selective surface device according to another embodiment of the disclosure;

FIG. 4 is an illustration of two of the frequency selective surfaces shown in FIG. 1, one coupled to clothing being worn by a person and another coupled to a piece of equipment being carried by the person;

FIG. 5 is a partially exploded view of the frequency selective surface coupled to clothing shown in FIG. 4;

FIG. 6 is a partially exploded view of the frequency selective surface coupled to piece of equipment FIG. 4;

FIG. 7 is a top plan view of a frequency selective surface according to an embodiment of the disclosure;

FIG. 8 is graph showing the results of a computer simulation test of the frequency selective surface shown in FIG. 7;

FIG. 9 is a top plan view of a frequency selective surface according to another embodiment of the disclosure, where the frequency selective surface is designed to reflect more than one radio frequency;

FIG. 10 is graph showing the results of a computer simulation test of the frequency selective surface shown in FIG. 9;

FIG. 11 is a schematic illustration of a system for identifying and locating a remote object utilizing the frequency selective surface of the present disclosure; and

FIGS. 12A, 12B, & 12C show flow diagrams illustrating methods of identifying and locating an object utilizing the frequency selective surface of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9,1-8,1-3,1-2,2-10,2-8,2-3,3-10,3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves communications systems and specifically to personnel recovery and signaling systems and methods utilizing electromagnetic radiation reflectors, also referred to as radio frequency reflectors or frequency selective surfaces (FSS).

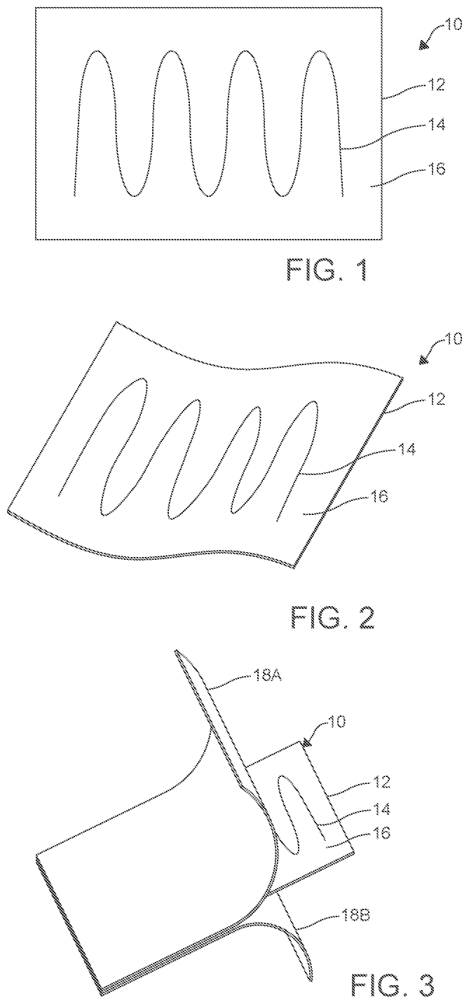

Referring now to FIGS. 1-3, a frequency selective surface 10 (hereinafter “FSS 10”) according to an embodiment of the present disclosure is shown. The FSS 10 includes a substantially planar substrate 12 including a radio frequency reflection element 14. It should be understood that the substantially planar substrate 12 is planar in its original configuration but that when in use, the substantially planar substrate 12 can take on non-planar configurations. The radio frequency reflection element 14 can be disposed on an outer surface 16 of the substantially planar substrate 12. Alternatively, the radio frequency reflection element 14 can be disposed within the interior volume of the substantially planar substrate 12. In a preferred embodiment, the FSS 10, including the substantially planar substrate 12 and the radio frequency reflection element 14, is flexible to allow an out-of-plane bending of the FSS 10.

As shown in FIG. 3, a material 18A can be applied on top of or provided as a covering for the radio frequency reflection element 14, where the radio frequency reflection element 14 is between the substantially planar substrate 12 and the material 18A. Additionally, the a material 18b can be utilized together with material 18A to encase the substantially planar substrate 12 and the radio frequency reflection element 14 to provide additional characteristics to the FSS 10, such as being waterproof or water resistant, for example. The materials 18A and 18B that can be utilized to cover and/or protect the radio frequency reflection element 14 can be a plastic, a polymer or a wax, for example. It should be understood that if the FSS 10 is encased in the materials 18A and 18B, at least one side of the FSS 10 should be covered with a material that is transparent with respect to at least the radio frequency or frequencies that are to be reflected by the radio frequency reflection element 14. The materials 18A, 18B can be applied as a solid, a liquid, a gas, solid particulates, or combinations thereof. Furthermore, the materials 18A, 18B can be a material from the clothing or equipment to which the FSS 10 is associated. For example, a material of the clothing, the patch, the badge, the emblem, the tag, and the equipment, for example, can be utilized as at least one of the materials 18A and 18B.

Furthermore, the material 18B can include a material that essentially prevents a radio frequency from passing therethrough and/or reflects essentially the entire emitted radio frequency spectrum (reflecting material), allowing the FSS 10 to be oriented with the reflecting material outwardly facing and the radio frequency reflection element 14 inwardly facing with respect to an associated object to conceal the passive reflection of the FSS 10, if desired. Furthermore, it should be understood that the substantially planar substrate 12 can be formed from the reflecting material, where orienting the FSS 10 with the substantially planar substrate 12 outwardly facing and the radio frequency reflection element 14 inwardly facing with respect to an associated object is effective to conceal the passive reflection of the FSS 10.

The material 18B can include a material that absorbs the entire emitted radio frequency spectrum (an absorbing material). Furthermore, it should be understood that the substantially planar substrate 12 can be formed from an absorbing material where the radio frequency reflection element 14 is formed on the surface of the substantially planar substrate 12. The reflected radio signal from the FSS 10 can be further distinguished by using the absorbing material as the emitted frequency will first encounter the radio frequency reflection element 14 which will reflect the designed specific frequency while the remainder of the emitted radio frequency spectrum will be absorbed by the radio frequency absorbing material used for the material 18 and/or the substrate 12. By absorbing the remainder of the emitted radio frequency spectrum in the area adjacent to the radio frequency reflection element 14, the reflected radio frequency from the radio frequency reflection element 14 will be further distinguishable.

Furthermore, in certain applications, both a reflecting material and an absorbing material can be utilized, where the radio frequency reflection element 14 is followed by the absorbing material and then the reflecting material. In this arrangement, when the radio frequency reflection element 14 is outwardly facing, the absorbing material will function to further distinguish the reflected radio frequency. Alternatively, when the radio frequency reflection element 14 is inwardly facing, the reflecting material will be outwardly facing from the object to conceal the passive reflection of the FSS 10. It should be understood that when both a reflecting material and an absorbing material are used, the substrate 12 can be an absorbing material and the material 18B can be the reflecting material. It should also be understood that an additional layer of material can be employed where one of the substrate 12 and the material 18B can be the absorbing material and the additional layer of material can be the reflecting material.

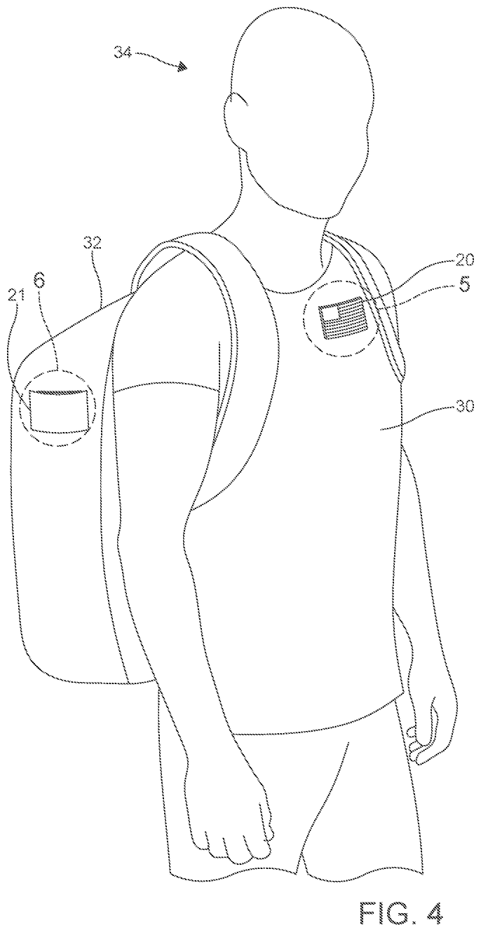

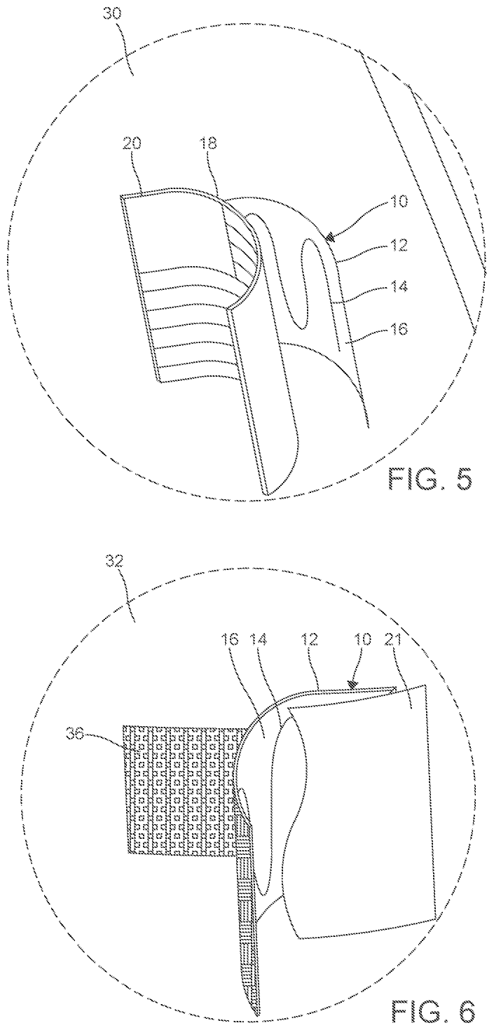

The FSS 10 can be incorporated into and/or coupled to clothing 30 or equipment 32, as shown in FIGS. 4-6. For example, the FSS 10 can be incorporated as part of a patch 20 or a pocket 21, for example, to conceal the presence of the FSS 10 as well as protect the FSS 10 and facilitate maintaining the FSS 10 in proximity of a user 34 wearing the clothing 32 and/or the equipment 32. It should be understood that the FSS 10 can be incorporated into a badge, an emblem, a panel, a tag, a pocket, and other parts of or attachments to the clothing 30 or the equipment 32, as desired. A hook and loop fastener 36 can be used to incorporate and/or couple the FSS 10 to the clothing 30 or the equipment 32 equipment. It should also be understood that an adhesive, an adhesive tape, or sewing, for example, can also be used to incorporate and/or couple the FSS 10 to the clothing 30 or the equipment 32 equipment. It should also be understood that the FSS 10 can be carried by the user or the equipment, where the FSS 10 can be disposed in a compartment, or other receptacle associated with the user 30 and/or the equipment 32. Furthermore, an object, including a person, can be provided with a plurality of the FSS 10, each configured to reflect the same radio frequency, wherein the plurality of the FSS 10 provide redundancy of reflections in the event the FSS 10 were to be lost or damaged and the option for a person dispose an FSS 10 at multiple locations to mark locations visited or for other purposes, for example. The initial planar configuration of the FSS 10 facilities incorporating the FSS 10 into and/or coupled to the clothing 30 or equipment 32 and carrying the FSS 10 the while the flexible nature of the FSS 10 facilitates a compliance with the clothing 30, the equipment 32, and conditions when in use.

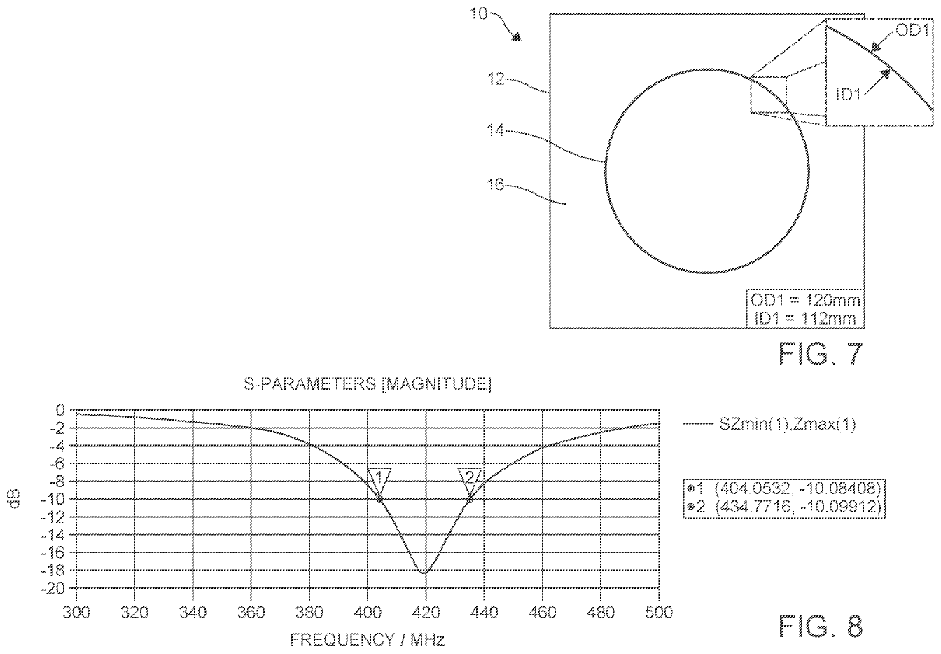

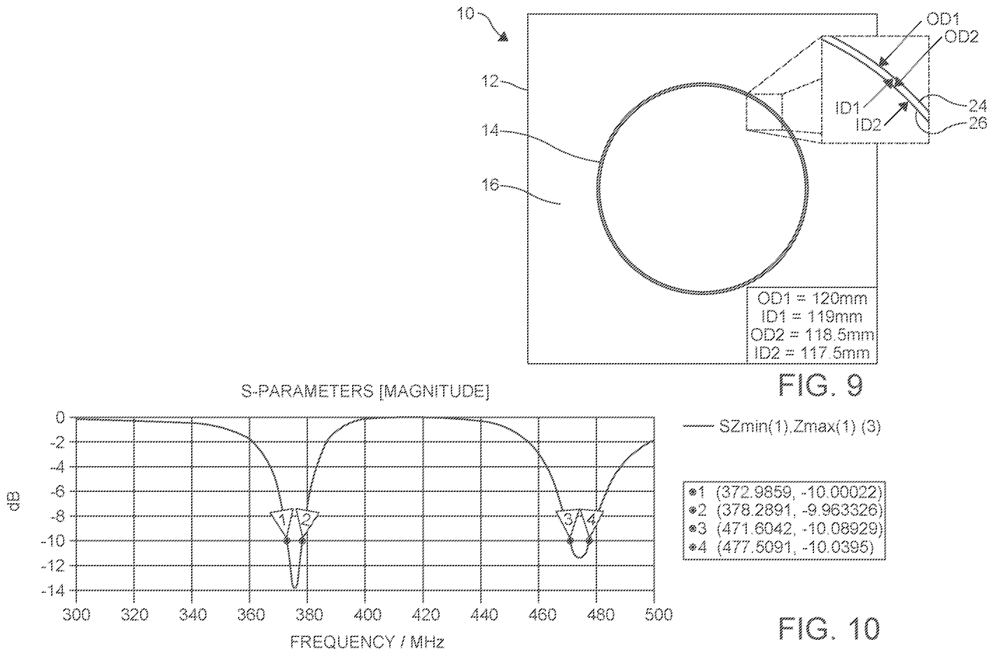

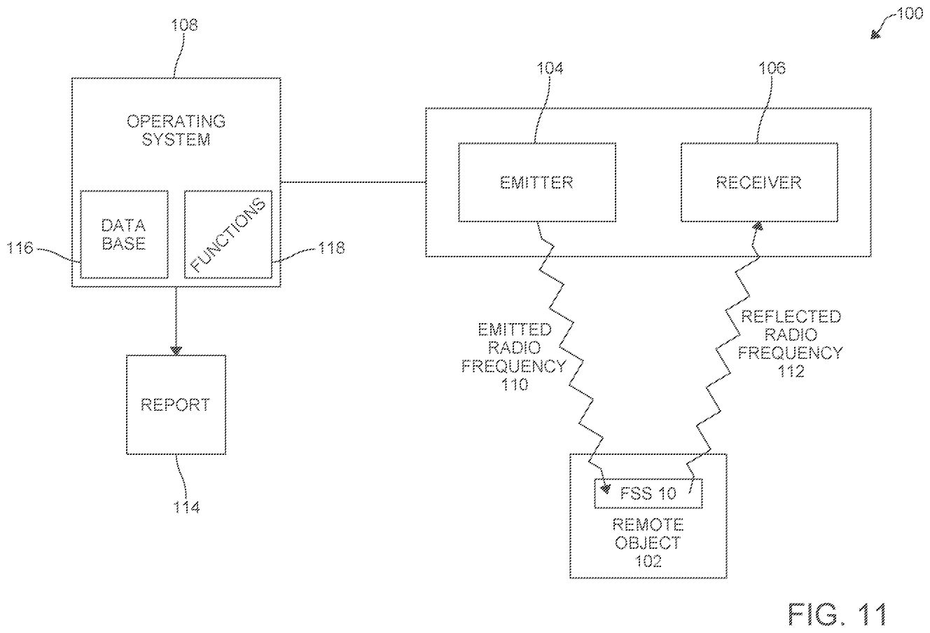

The substantially planar substrate 12 can be any suitable flexible material having properties to receive and support the radio frequency reflection element 14. In the embodiments illustrated in FIGS. 7 and 9, the substantially planar substrate 12 is paper. However, it should be understood that other materials can be used as desired including natural and synthetic fabrics, polymer and plastic materials. Additionally, individual ones of the substantially planar substrate 12 can be obtained from larger pieces of the material, or can be individually manufactured using a printing process or other suitable manufacturing method.

The radio frequency reflection element 14 deposed on the substantially planar substrate 12 can be an antenna configured to reflect a specific radio frequency and/or a narrow band of radio frequencies. In certain embodiments, the reflected radio frequency includes frequencies in a range between 3 MHz to 30 Ghz. It should be understood that the radio frequency reflection element 14 can be configured to reflect other frequencies and frequencies in other ranges and other remote detecting systems, including LiDAR, other current and emerging emitter/receiver systems, and/or any other frequencies in the electromagnetic spectrum. For example, a wide band RF signal can be emitted and all but the specific radio frequency and/or the narrow band of radio frequencies pass through the radio frequency reflection element 14, where only the specific radio frequency and/or the narrow band of radio frequencies is reflected. The radio frequency reflection element 14 can be formed utilizing conductive materials typically utilized for antennas, such as copper, graphene, and other metals. Additionally, other materials can be used such as electrically conductive inks, paints, polymers, and other materials now known or later discovered with sufficient electrical conductivity to function as an antenna. Furthermore, the radio frequency reflection element 14 can be formed by various manufacturing techniques including printing of the antenna material on the substantially planar substrate 12, for example. It should be understood that the radio frequency reflection element 14 can be configured to reflect more than one radio frequency to provide multiple reflection peaks that form a barcode like reflected signature. It should also be understood that the FSS 10 can be provided with more than one radio frequency reflection element 14, where each of the radio frequency reflection elements 14 can be configured to reflect a different radio frequency, to provide multiple reflection peaks that form a barcode like reflected signature.

With reference to FIGS. 7 and 9, the radio frequency reflection element 14 is formed by printing a conductive ink, such as VorINK S912 conductive ink from Vorbeck Materials Corporation (Jessup, MD), on the substantially planar substrate 12 that is paper. Favorable results for the FSS 10 including the radio frequency reflection element 14 formed from a printed conductive ink can be modeled using CST Studio Suite software.

In the embodiment illustrated in FIG. 7, the radio frequency reflection element 14 is designed as a single circular loop intended to provide one reflection peak. An inside diameter ID1 and an outside diameter OD1 of the single circular loop 20 are about 112 mm and 120 mm, respectively. Using CST Studio Suite software, the FSS 10 design shown in FIG. 7 was modeled and tested. The predicted S12 transmission results are shown in FIG. 8 with reflection bandwidths <−10 dB indicated by markers. The results indicate that the given design will reflect >90% (−10 dB) of incident radiation will back to an emitter and/or receiver between about 404.0 MHz and 434.8 MHz.

In the embodiment illustrated in FIG. 9, the radio frequency reflection element 14 is designed as a double circular loop or two separate radio frequency reflection elements 14 designed to provide two reflection peaks. An inside diameter OD1 and an outside diameter OD1 of an outer circle 24 are about 119.0 mm and 120.0 mm, respectively, and an inside diameter ID2 and an outside diameter OD2 of an inner circle 26 are about 117.5 mm and 118.5 mm, respectively. Using CST Studio Suite software, the FSS 10 design shown in FIG. 9 was modeled and tested. The predicted S12 transmission results are shown in FIG. 10 with reflection bandwidths <−10 dB indicated by markers. The results indicate that the given design will reflect >90% (−10 dB) of incident radiation back to an emitter and/or receiver between about 372.9 MHz and 378.3 MHz as well as between 471.6 MHz and 477.5 MHz. The simulation results also indicate that the double circular loop 22 can provide multiple reflection peaks.

The FSS 10 can be utilized as part of a system 100 for identifying and locating a remote object 102, where the object can be a person, a vehicle, a piece of equipment, or any other object that one desires to be able to passively identify and locate from a remote position. As shown in FIG. 9, the system 100 can include the FSS 10 that is associated with the remote object 102, a radio frequency emitter 104, a radio frequency receiver 106, and an operating system 108. The radio frequency emitter 104 is configured to emit a radio frequency or radio frequencies or radio frequency band 110 that the radio frequency reflection element 14 of the FSS 10 is designed to reflect. It should be understood that the radio frequency emitter 104 can be based on a terrestrial based emitter, a water based emitter, an aerial based emitter, an aircraft based emitter, and an extra-terrestrial based emitter. The radio frequency receiver 106 is configured to receive a reflected radio frequency or a signature reflection 112 from the radio frequency reflection element 14 of the FSS 10, where the signature reflection 112 includes or acts as identifying information of the FSS 10 and the associated remote object 102. It should be understood that the signature reflection 112 can be a single reflected radio frequency, two or more reflected radio frequencies, a band of radio frequencies including a peak value frequency, and two or more bands of radio frequencies where each band includes a peak value radio frequency. It should be understood that the radio frequency receiver 106 can be based on a terrestrial based receiver, a water based receiver, an aerial based receiver, an aircraft based receiver, and an extra-terrestrial based receiver. Furthermore, it should be understood that the radio frequency emitter 104 and the radio frequency receiver 106 can share a platform, have separate platforms, and/or be integrated together into a single system such as a radar system, for example. The signature reflection 112 from the radio frequency reflection element 14 can be associated with the remote object 102 that is desired to be remotely identified and located. The operating system 108 can be in communication with the radio frequency emitter 104 and the radio frequency receiver 106, where the operating system 108 is configured to control the emitting of the radio frequency 110, control the reception of the signature reflections 112, conduct an analysis of the signature reflections 112 and provide an output or report 114 regarding the identification and location of the remote object 102.

The operating system 108 includes a database 116 and functions 118. The database 116 includes information regarding the association of the remote object 102 to the FSS 10 coupled thereto or carried thereby, including the signature reflection 112 from the radio frequency reflection element 14 of the FSS 10. It should be understood that the database 116 can also include other information regarding or associated with the remote object 102 and/or be linked to other databases and systems that have such additional information. The functions 118 include a capability to analyze the signature reflection 112 received by the radio frequency receiver 106 and provide the report 114 including the identification of the remote object 102 associated with that the signature reflection 112. The identification of the remote object 102 can include a name, a serial number, a model number, and/or other information regarding the remote object 102. The functions 118 can also include a location deriving capability that utilizes the signature reflection 112 to determine a location of the remote object 102 and include the location in the report 114.

Utilizing the location of the remote object 102, the report 114 can also include other information related to the location, such as current and forecasted weather conditions, terrain, or status of current conflicts or political issues at the location or the region, for example. The report can be utilized to plan and execute a recovery of the remote object 102 or provide support to the remote object 102 by deploying additional resources to the location, for example.

The system 100 can be particularly useful when the remote object 102 is incapacitated in some manner, where the remote object cannot self-trigger a signal to a support center or person, as the FSS 10 is a passive system that requires no electrical energy or user interaction to provide the signature reflection 112 of the radio frequency 110 emitted by the radio frequency emitter 104. For example, a wounded soldier or injured/lost hiker may not be physically capable to use conventional devices such as radios, cell phones, flares, and smoke signals, for example, or be able to assemble and deploy known passive geodesic structures that include frequency selective surfaces. Additionally, the remote object 102 can be an animal or an inanimate object incapable of self-triggering a signal to a support center or assembling and deploying a signaling device, where the passive capability of the system 100 enables such remote objects 102 to be identified, located, tracked, and recovered.

Furthermore, in certain situations where stealth is required, the passive capability of the system 100 allows for identifying and locating the remote object 102 with minimal risk of a third party also identifying and locating the remote object 102 and/or minimal risk that a third party is aware that the remote object 102 is equipped with the FSS 10 or engaged with the system 100. Non-passive devices typically include the capability to emit a radio signal. The emitted signal can be received by the intended recipient but can also often be detected by a third party. Accordingly, in a hostile environment such as a war zone or covert operation, it is undesirable for the remote object 102 to emit a signal that can be detected by the third party and used to identify and locate the remote object 102.

Additionally, the system 100 can be useful when the remote object 102 is located in a GPS (Global Positioning System) denied environment and environments where GPS systems may not be reliable. In such environments, parties depending on GPS to locate objects are essentially “blind” to where such remote objects 102 are located. These environments can be encountered in war zones or regions of political upheaval and where political and civil strife are present, or where impediments to line-of-site transmissions are present. The passive capability enables the users of the system 100 to continue to efficiently operate in these areas by utilizing the system 100 which is independent from GPS or other broad use communication systems utilizing cell towers, radio transmissions, and/or the internet.

Furthermore, the system 100 can be useful for the positive identification and/or location (to include but not limited to, range and bearing, speed of movement, orientation, size, type, ect.) of objects (e.g., trucks, cars, vans, motorcycles, trailers, vessels, aerial platforms, signs, etc.) and/or people as part of an overall safety system utilized to augment and/or control all and/or part of a human or computer controlled transportation system. In such applications, the FSS 10 can be associated with such objects and/or people to quickly identify and/or locate the objects and/or people, where the identity and location can be inputs to systems for controlling and/or driving vehicles and the like, as well as inputs to other human or computer controlled transportation systems.

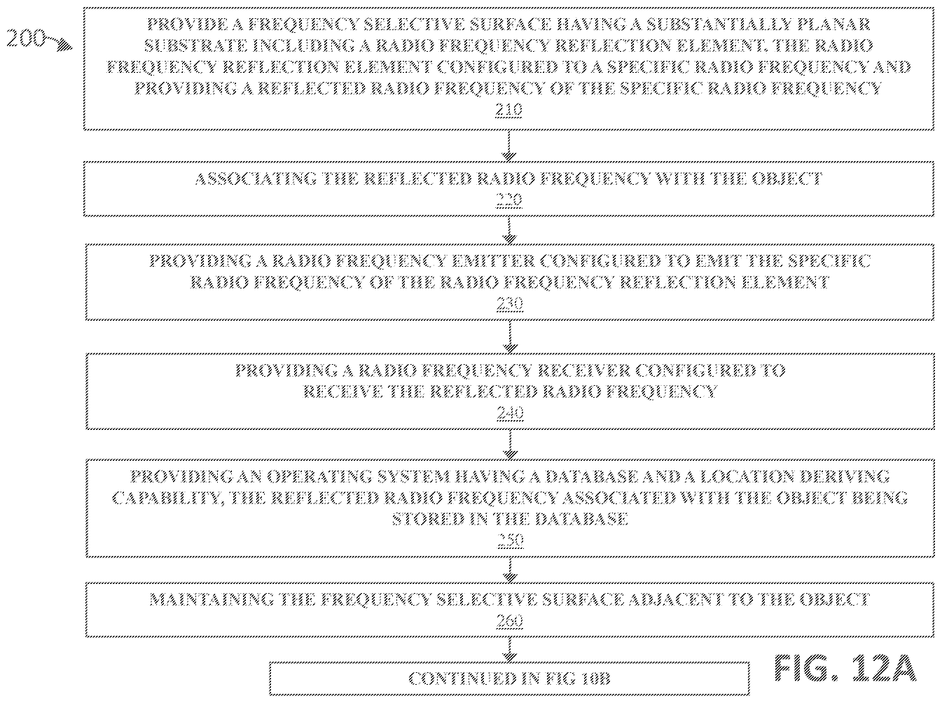

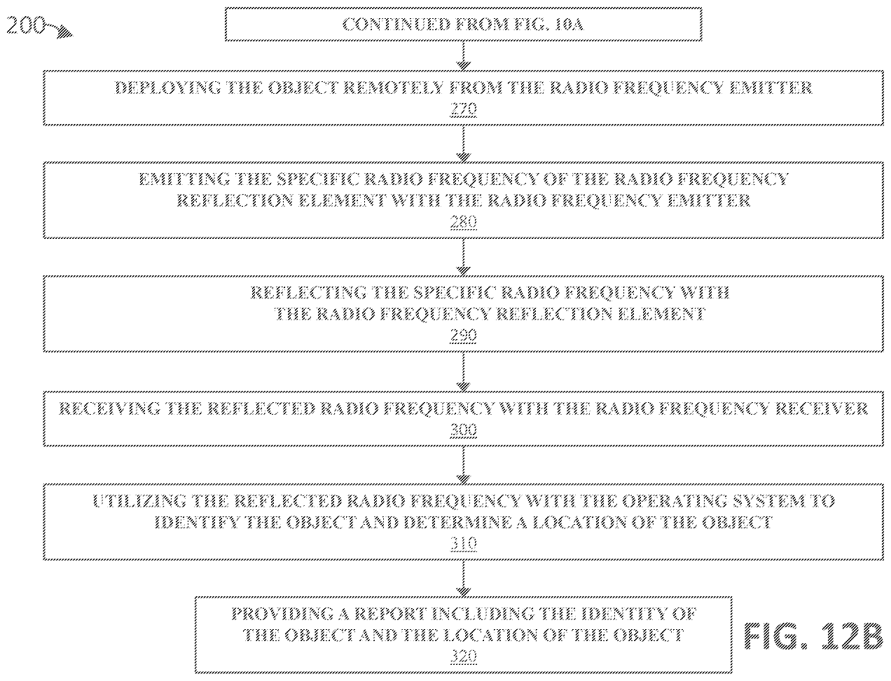

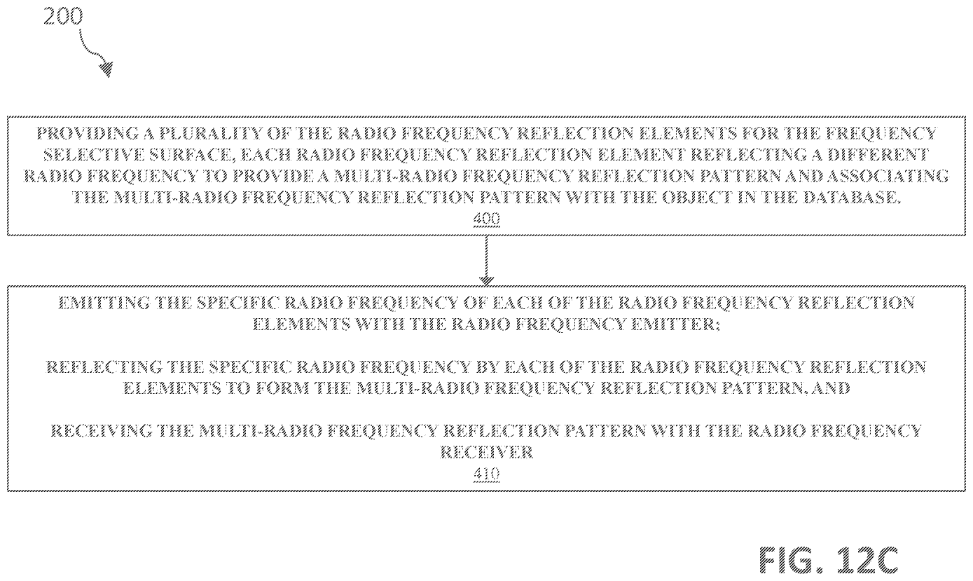

A method 200 of identifying and locating an object is shown in FIGS. 12A-12B. It should be appreciated that the following steps may occur in various consecutive orders with respect to each other, including where certain steps may be performed simultaneously, or with other steps. The method 200 includes step 210 of providing the FSS 10 having the substantially planar substrate 12 including a radio frequency reflection element 14, the radio frequency reflection element configured to a specific radio frequency and providing a reflected radio frequency of the specific radio frequency. In step 220, the reflected radio frequency is associated with the object. A a radio frequency emitter configured to emit the specific radio frequency of the radio frequency reflection element is provided in step 230 and a radio frequency receiver configured to receive the reflected radio frequency is provided in step 240. An operating system is provided in step 250, wherein the operating system includes a database and a location deriving or determining capability, and the reflected radio frequency associated with the object being stored in the database.

In step 260, the frequency selective surface is maintained in proximity to the object. It should be understood that the frequency selective surface can be coupled to or carried by the object in order to maintain the frequency selective surface in proximity to the object. In step 270, the object is deployed remotely from the radio frequency emitter.

When it is desired to identify and locate the object, the specific radio frequency of the radio frequency reflection element is emitted in step 280 with the radio frequency emitter. In step 290, the specific radio frequency is reflected by the radio frequency reflection element. In step 300 the reflected radio frequency is received by the radio frequency receiver. Step 310 includes utilizing the reflected radio frequency with the operating system to identify the object and determine a location of the object.

The method 200 can also include step 320 of providing a report including the identity of the object and the location of the object. It should be understood that the report can include other information regarding the object and the location of the object, where the information in the report can be utilized to plan and execute a recovery of the object or provide support to the remote object 102 by deploying additional resources to the location, for example.

Additionally, as shown in FIG. 12C, the method 200 can include steps 400 and 410. Step 400 includes providing a plurality of the radio frequency reflection elements for the FSS 10, where each radio frequency reflection element reflects a different radio frequency to provide a multi-radio frequency reflection pattern and the multi-radio frequency reflection pattern is associated with the object in the database of the operating system. In step 410, the specific radio frequency of each of the radio frequency reflection elements is emitted by the radio frequency emitter and then reflected by the radio frequency reflection to form the multi-radio frequency reflection pattern, and the multi-radio frequency reflection pattern is received by the radio frequency receiver.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A frequency selective surface comprising a substantially planar substrate including a radio frequency reflection element, the radio frequency reflection element configured to a specific radio frequency and provide a reflected radio frequency of the specific radio frequency.

2. The frequency selective surface of claim 1, wherein the reflected radio frequency provides at least one of an identifying information and locating information of the frequency selective surface.

3. The frequency selective surface of claim 1, wherein the frequency selective surface includes at least one of a radio frequency reflective material and a radio frequency absorbing material.

4. The frequency selective surface of claim 1, wherein the substantially planar substrate and the radio frequency reflection element are flexible to allow an out-of-plane bending of the frequency selective surface.

5. The frequency selective surface of claim 1, wherein the reflected radio frequency includes frequencies in a range between 3 MHz to 30 Ghz.

6. The frequency selective surface of claim 1, wherein the frequency selective surface includes a plurality of the radio frequency reflection elements, each radio frequency reflection element reflecting a different radio frequency.

7. A system for identifying and locating a remote object, the system comprising:
a frequency selective surface having a substantially planar substrate including a radio frequency reflection element, the radio frequency reflection element configured to a specific radio frequency and provide a reflected radio frequency of the specific radio frequency, the frequency selective surface configured to be maintained in proximity to the remote object;
a radio frequency emitter configured to emit the specific radio frequency of the radio frequency reflection element;
a radio frequency receiver configured to receive the reflected radio frequency; and
an operating system including a database and a location deriving capability, the reflected radio frequency associated with the remote object in the database, and the operating system configured to utilize the reflected radio frequency received by the radio frequency receiver to identify the remote object and determine a location of the remote object.

8. The system for identifying and locating a remote object of claim 7, wherein the frequency selective surface is flexible to allow an out-of-plane bending of the frequency selective surface.

9. The system for identifying and locating a remote object of claim 7, wherein the frequency selective surface is coupled to the remote object.

10. The system for identifying and locating a remote object of claim 7, wherein the frequency selective surface is carried by the remote object.

11. The system for identifying and locating a remote object of claim 7, wherein the reflected radio frequency includes frequencies in a range between 3 MHz to 30 Ghz.

12. The system for identifying and locating a remote object of claim 7, wherein the frequency selective surface includes a plurality of the radio frequency reflection elements, each radio frequency reflection element reflecting a different radio frequency to form a multi-radio frequency reflection pattern associated with the remote object.

13. The system for identifying and locating a remote object of claim 7, wherein the radio frequency emitter includes a member selected from a group consisting of a terrestrial based emitter, a water based emitter, an airborne based emitter, an extra-terrestrial based emitter, and combinations thereof.

14. The system for identifying and locating a remote object of claim 7, wherein the radio frequency receiver includes a member selected from a group consisting of a terrestrial based receiver, a water based receiver, an airborne based receiver, an extra-terrestrial based receiver, and combinations thereof.

15. A method of identifying and locating an object, comprising:
providing a frequency selective surface having a substantially planar substrate including a radio frequency reflection element, the radio frequency reflection element configured to a specific radio frequency and provide a reflected radio frequency of the specific radio frequency;
associating the reflected radio frequency with the object;
providing a radio frequency emitter configured to emit the specific radio frequency of the radio frequency reflection element;
providing a radio frequency receiver configured to receive the reflected radio frequency;
providing an operating system having a database and a location deriving capability, the reflected radio frequency associated with the object being stored in the database;
maintaining the frequency selective surface in proximity to the object;
deploying the object remotely from the radio frequency emitter;
emitting the specific radio frequency of the radio frequency reflection element with the radio frequency emitter;
reflecting the specific radio frequency with the radio frequency reflection element;
receiving the reflected radio frequency with the radio frequency receiver; and
utilizing the reflected radio frequency with the operating system to identify the object and determine a location of the object.

16. The method of identifying and locating an object of claim 15, including providing a report including the identity of the object and the location of the object.

17. The method of identifying and locating an object of claim 15, including coupling the frequency selective surface to the object.

18. The method of identifying and locating an object of claim 15, including having the object carry the frequency selective surface.

19. The method of identifying and locating an object of claim 15, wherein the frequency selective surface includes a plurality of the radio frequency reflection elements, each radio frequency reflection element reflecting a different radio frequency to provide a multi-radio frequency reflection pattern, the multi-radio frequency reflection pattern associated with the object being stored in the database.

20. The method of identifying and locating an object of claim 19, wherein:
emitting the specific radio frequency of the radio frequency reflection element with the radio frequency emitter includes emitting the specific radio frequency of each of the radio frequency reflection elements with the radio frequency emitter;
reflecting the specific radio frequency with the radio frequency reflection element includes reflecting the specific radio frequency by each of the radio frequency reflection elements to form the multi-radio frequency reflection pattern; and
receiving the reflected radio frequency with the radio frequency receiver includes receiving the multi-radio frequency reflection pattern with the radio frequency receiver.
